(19) United States
(12) Patent Application Publication
(10) Pub. No.: US 2013/0257473 A1
(43) Pub. Date: Oct. 3, 2013

(54) LONG-LIFE POWER SOURCE, LONG-LIFE EMBEDDED STRUCTURE SENSOR, REMOTE LONG-LIFE FLUID MEASUREMENT AND ANALYSIS SYSTEM, LONG-LIFE OFF-GRID ENCLOSED SPACE PROXIMITY CHANGE DETECTOR, SURFACE-MOUNT ENCRYPTION DEVICE WITH VOLATILE LONG-LIFE KEY STORAGE AND VOLUME INTRUSION RESPONSE, AND PORTABLE ENCRYPTED DATA STORAGE WITH VOLATILE LONG-LIFE KEY STORAGE AND VOLUME INTRUSION RESPONSE

(71) Applicants: Christian Adams, Yalaha, FL (US); Joseph M. Wright, Southlake, TX (US); Patrick A. Nelson, Orlando, FL (US); Kenneth S. Gurley, Windermere, FL (US); Richard A. Vaughn, Arlington, TX (US)

(72) Inventors: Christian Adams, Yalaha, FL (US); Joseph M. Wright, Southlake, TX (US); Patrick A. Nelson, Orlando, FL (US); Kenneth S. Gurley, Windermere, FL (US); Richard A. Vaughn, Arlington, TX (US)

(73) Assignee: Lockheed Martin Corporation, Bethesda, MD (US)

(21) Appl. No.: 12/504,482

(22) Filed: Jul. 16, 2009

Related U.S. Application Data
(60) Provisional application No. 61/129,755, filed on Jul. 16, 2008.

(51) Int. Cl. G06F 21/86; G21H 1/02

(52) U.S. Cl. CPC G06F 21/86; G21H 1/02
USPC 326/8; 136/253

(57) ABSTRACT

A long-life embedded structure sensor, remote long-life fluid measurement and analysis system, long-life off-grid enclosed space proximity change detector, surface-mount encryption device with volatile long-life key storage and volume intrusion response, and a portable encrypted data storage with volatile long-life key storage and volume intrusion response are provided to be powered by and equipped with a long-life power source that can provide operative power for at least a twenty year duration.

### BACKGROUND

Many portable and/or remote consumer, defense, manufacturing and commercial devices, for example, utilize a power source for operation, such as a battery. The operating costs to service and maintain such products increases due to the need to replace the power source. Operating efficiencies of such products are also affected and limited due to the operating lifespan of the power source. The limited lifespan of conventional power sources limits potential applications of products utilizing conventional power sources, and hampers development of products that could operate more efficiently than existing products utilizing conventional power sources.

### SUMMARY

An exemplary embodiment provides a device comprising a long-life power source configured to supply operating power to the device for a duration of at least twenty years. The exemplary device also comprises a package housing configured to secure the power source integral to the device, and a processing unit configured to control operative functions of the device. In addition, the exemplary device comprises a power control unit configured to supply power to the processing unit based on the operating power supplied from the power source.

### BRIEF DESCRIPTION OF THE DRAWINGS

Further advantages and refinements of the present disclosure are explained in more detail below with reference to exemplary embodiments which are illustrated in the attached drawings, in which:

FIG. 1 is a block diagram of a device powered by a long-life power source, according to at least one embodiment;

FIG. 2 is an illustration of an exemplary structural material in which a sensor powered by a long-life power source can be embedded, according to at least one embodiment;

FIG. 3 is an illustration of an exemplary device including a sensor that is powered by a long-life power source and that can be immersed in a fluid, according to at least one embodiment;

FIG. 4 is an illustration of an exemplary environment in which a sensor powered by a long-life power source can be installed to detect changes in the environment, according to at least one embodiment;

FIG. 5 is an illustration of an exemplary surface mount encryption device powered by a long-life power source and mountable to a computer processing device, according to at least one embodiment; and

FIG. 6 is an illustration of an exemplary portable encryption device powered by a long-life power source and removably inserted into a communication port of a computer processing device, according to at least one embodiment.

### DETAILED DESCRIPTION OF EXEMPLARY EMBODIMENTS

An exemplary embodiment provides a long-life power source, such as a battery. As used herein, the term “long-life power source” encompasses a power source that is configured to supply an operating power for a duration of at least twenty or more years. As used herein, the term “operating power” means the power required to operate a device in the manner that the device is intended to operate. Examples of long-life power sources are described below. It is to be understood, however, that the present disclosure is not limited to the exemplary long-life power sources described hereinafter. Rather, exemplary devices of the present disclosure incorporating a long-life power source, as described hereinafter, can be powered from any conceivable long-life power source capable of supplying an operating power to the device for a duration of at least twenty or more years.

An exemplary long-life power source can be a betavoltaic power source, for example. Another exemplary long-life power source can be a nuclear spin power source, for example. Yet another exemplary power source can be a remnant polarization power source, for example. In addition, another exemplary long-life power source can be a radio-luminescent photovoltaic power source, for example. These exemplary categories of power sources can have a lifespan of numerous years beyond that of conventional power sources, such as approximately 10 to 20 years or more, for example.

A p-n junction of the exemplary betavoltaic power source relies on a beta particle emitter for energy. An exemplary beta particle emitter can be a form of tritium (T or ³H), which is an isotope of hydrogen. Tritium can be locked up in a polymer form, where the tritium replaces some or all of hydrogen which is commonplace in polymers, or bound to a metal in a tritide state, analogous to metal hydride.

The exemplary betavoltaic battery can include, among other constituent elements, a p-n junction and a type of beta emitter, such as tritium, for example, in contact with the p-n junction. These components are then packaged. The package effectively prevents a radioactivity leak, unless the structured package is violated.

The exemplary betavoltaic power source may include a stacked thin-film arrangement, where a p-n junction is in contact with a PVD (physical vapor deposition) or CVD (chemical vapor deposition) layer of trilated metal, such as titanium and scandium, for example. The p-n junction can exemplarily be formed from a thin film aluminum gallium arsenide (AlGaAS), gallium arsenide (GaAs), or silicon carbide (SiC), for example. According to one exemplary configuration, the betavoltaic power source can have a power output of approximately 70 nanoamps at 0.7 volts for a single 1 cm² cell. An adjacent (stacked) cell can share the same tritium layer for double that output with the same quantity of isotope. With a thickness of 100 microns per layer, for example, the betavoltaic power source can be stacked according to the desired current and voltage output. Output can diminish according to the half-life of the isotope, which in the case of tritium is approximately 12.3 years. To increase the power supply to a half-life of 20 years, for example, the tritium can be front-loaded to provide the requested output at the half-life of the isotope.

Exemplary types of long-life betavoltatic power sources are disclosed in U.S. Pat. No. 7,250,323, U.S. Patent Application Publication No. 2008/0200628, U.S. 2008/0199736, and U.S. Pat. No. 7,301,254, for example.

The nuclear spin and remnant polarization power sources differ from the betavoltaic power source in that no radioactive materials are used. Instead, the innate property of nuclear spin and remnant polarization is respectively harnessed so that an electrical flow is generated. The electrical flow is stimulated when a material with high nuclear spin or remnant polarization is layered with some combination of any of the following: (i) a ferroelectric material, (ii) a piezoelectric material, and (iii) is placed in the presence of a permanent magnetic field.

Similar to the betavoltaic power source, the nuclear spin power source includes a layered stacked arrangement. The layered stacked arrangement, however, is thicker than conventional “thick film” products, and can utilize the so-called “thick film” manufacturing method. An exemplary configuration of the nuclear spin power source can generate a power output profile similar to a capacitor discharge, except that instead of falling off to zero, the output asymptotically approaches a lower level voltage. The initial pulse (approximately 100 milliseconds) is a higher voltage (approximately 80 volts) and rapidly falls off to single-digit voltages. In this exemplary configuration, current is in the tens of microamperes per layer. According to an exemplary embodiment, the power output can be flattened, the cells can be stacked, and a constant power supply can be provided.

Since there is no radioactive isotope with the exemplary nuclear power source, the power output does not diminish even after a prolonged time period, such as 20 years or more, for example. An exemplary type of nuclear spin and remnant polarization power sources is disclosed in U.S. Patent Application Publication No. 2008/0246366, for example.

Radio-luminescent photovoltaic power sources can be considered to be an indirect power source, when compared to betavoltatic power sources. In such radio-luminescent photovoltaic power sources, radioactivity from a radioactive element (e.g., tritium) can cause a phosphor glow, which in turn causes a solar cell-type semiconductor to generate power. Therefore, unlike a betavoltaic power source which involves a direct conversion of beta radiation into power, a radio-luminescent photovoltaic power source can be considered to be an indirect power generator in that a beta emitter (e.g., tritium) can cause a phosphor to glow, which in turn causes a solar cell-type semiconductor to generate power. An exemplary type of a radio-luminescent photovoltaic power source is disclosed in U.S. Pat. No. 4,889,660, for example.

The exemplary long-life power sources described above can be integrated with memory backup mechanisms, and integrate a lithium ion trickle charging capability to existing and future-developed products.

By having a superior, long-life power supply, applications can provided which were not possible or conceivable before because of the limited life and operating power of conventional power sources. Exemplary embodiments of the present disclosure provide devices that can accommodate and be powered by any of the exemplary long-life power sources as described above. Examples of such devices are described hereinafter. As noted above, exemplary devices of the present disclosure are not to be construed as being limited to the examples of long-life power sources described above. The long-life power sources described above are exemplary types of long-life power sources. Exemplary devices can be powered from any conceivable long-life power source that is capable of supplying an operating power to the device for a duration of at least twenty or more years.

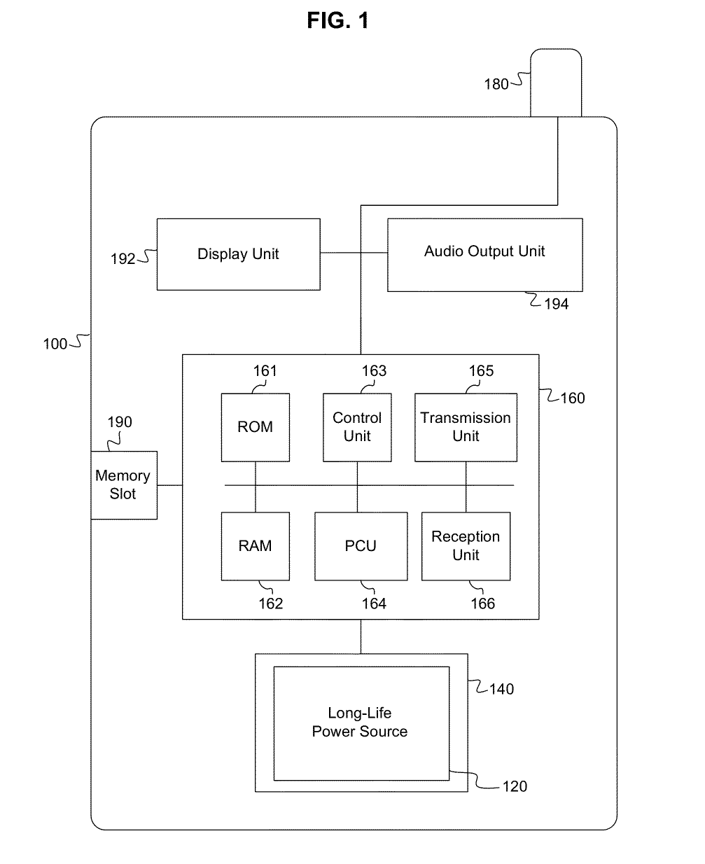

FIG. 1 is a block diagram of a device 100 powered by a long-life power source, according to at least one embodiment. As illustrated in the example of FIG. 1, the device 100 includes a long-life power source 120 that can be any of the exemplary power sources as described above, for example. The long-life power source 120 is encompassed within a package housing 140 that secures the power source 120 to be integral to the device 100 (e.g., within the device 100). The exemplary device 100 can also include a processing unit 160 that is configured to control the operative functions of the device 100. As used herein, the term “operative functions” means the functions that the device is designed to perform. The processing unit 160 is comprised of hardware circuitry configured to control the aggregate operations of the device 100.

According to an exemplary embodiment, the processing unit 160 can include a ROM (read-only memory) 161, a RAM (random access memory) 162, a control unit 163, a power control unit 164, a transmission unit 165, and a reception unit 166. The control unit 163 includes hardware circuitry configured to control the aggregate functions of each component of the device 100 as well as the interrelationship and interaction between the other components of the device 100. As an example of the hardware circuitry, the control unit 163 can include, for example, a processor constituting an electronic circuit for controlling the operations of the device 100. The ROM 161 can store computer-readable programs, such as an operating system (OS) and application programs, and logic instructions which are implemented by the control unit 163. The RAM 162 can be used as a working memory by the control unit 163 when executing the programs and logic instructions stored in the ROM 161. A power control unit (PCU) 164 is controlled by the control unit 163 to obtain power from the long-life power source 120 when the power is required for operation of the device 100, and supply an appropriate amount of power to the various constituent elements of the device 100 (e.g., the control unit 163), based on the operating power supplied from the long-life power source 120.

According to an exemplary embodiment, the device 100 can include an antenna 180 to transmit and receive data external to/from the device 100. For clarity of illustration, the antenna 180 is illustrated in FIG. 1 as extending from the main body of the device 100. However, the antenna 180 can be integrated within the main body of the device 100 as an internal antenna that does not extend from the main body of the device 100. The antenna 180 operates in concert with a transmission unit 165 and a reception unit 166 of the processing unit 160. The processing unit 160 controls the transmission unit 165 to cause the antenna 180 to transmit data external to the device 100, and controls the reception unit 166 to receive data transmitted externally from the device 100. According to an exemplary embodiment, the processing unit 160 can convert any data produced in the device 100 to be transmitted wirelessly to a device configured to receive such data. For example, the processing unit 160 can control the transmission unit 165 to cause the antenna 180 to transmit data as a RF transmission at a predetermined time and/or predetermined frequency.

According to an exemplary embodiment, the device 100 can include a display unit 192 and/or an audio output unit 194 as two examples of output devices. The display unit 192 can output visual representations of data produced in the device 100, and the audio output unit 194 can output audible representations of data produced in the device 100. For example, the audio output unit 194 can include a speaker for outputting audible representations of data produced in the device 100.

According to an exemplary embodiment, the device 100 can also include a memory slot 190 configured to receive a removable memory card inserted therein. The memory slot 190 can communicatively couple terminals of the removable memory card to the processing unit 160 to provide the components of the processing unit 160 access to data and programs stored on the memory card 190, and to store data thereon.

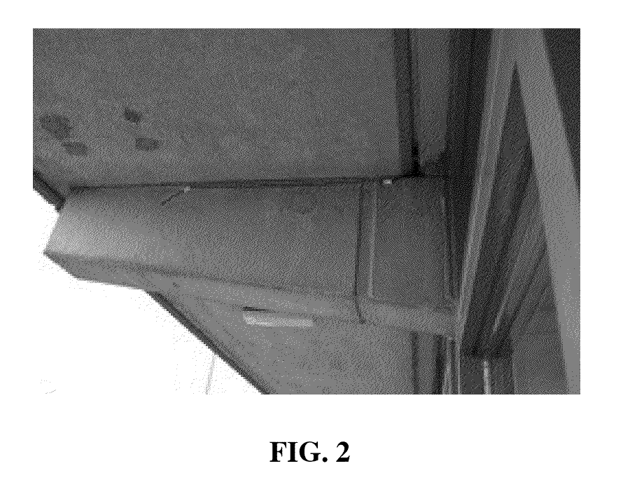

FIG. 2 is an illustration of an exemplary structural material in which a sensor powered by a long-life power source can be embedded, according to at least one embodiment. For instance, according to an exemplary configuration of the device 100, the present disclosure provides a long-life embedded structure sensor that can be embedded within a solid material or positioned between solid materials. For example, the long-life embedded structure sensor can be embedded inside composite or homogenous structural materials, such as concrete, for example, used for constructing residences, buildings, power plants, runways, bridges, tunnels, dams, monuments, etc., or positioned in between metallic hull sections at weld points, or positioned in between composite layer sections. The sensor can provide single-vector (e.g., stress, moisture, air intrusion, etc.) sensor/monitoring information to a surveyor or engineer, for example. The sensor can be embedded in the structural material without impacting the structural integrity of any the structures in or between which the sensor is embedded or positioned.

The sensor can include a measurement device configured to measure environmental information of the structural material in which the sensor is embedded, and/or an environment in proximity to the structural material in which the sensor is embedded. For example, the measurement device of the sensor can be configured to measure environmental information such as stress, pressure, temperature and elevation values of the structural material in which the sensor is embedded, for example. Such values can be measured to monitor the health and/or vitality of the structural material for notification of an impending failure, for example, or the environmental information can be measured to monitor whether the structural material requires maintenance, for example. Such a sensor can also be effective in monitoring changes to an environment proximate to the structural material (i.e., within a predetermined distance of the location in the structural material in which the sensor is embedded), to notify appropriate personnel of changing environmental conditions that may require attention.

The processing unit 160 can control the transmission unit 165 and antenna 180 to transmit the measured environmental information to a receiving device external to the sensor that is configured to receive the measured environmental information. For example, the processing unit 160 can be configured to convert the measured environmental information into a transmission signal, and control the transmitter 165, 180 to transmit the transmission signal wirelessly via a radio frequency at a predetermined period of time.

The sensor can be powered by any of the exemplary long-life power sources described above, and thereby enables data collection and the generation of a periodic RF (radio frequency) burst to allow the surveyor and/or engineer, for example, to receive data indicating performance or failure information. In the example where the sensor(s) is/are embedded in a material such as concrete, for example, the sensor(s) may be spherical in shape so as to negate an impact on the structural integrity of the material in which it is embedded. Similarly, in the example where the sensor is embedded or positioned between layers of material, such as composite material, for example, the sensor can be flush with the materials (e.g., flush with metallic hull sections), or if provided at weld points, the sensor can be substantially flat to minimize footprint and maximize contact area.

As described above, the sensor can include a transmitter (e.g., antenna 180 and transmission unit 165) to transmit the measured data. The data stream can provide a three-dimensional multi-coordinate assessment of setting patterns of the material, such as concrete, for example. Similar detailed mapping information may be collected and transmitted for structures where failure of the structural materials is of concern, or when the structural materials are detected to be in need of repair because of overuse or damage thereto.

Another exemplary embodiment of the present disclosure provides a remote long-life fluid measurement and analysis system. Conventionally, no active flow-meter/waste-stream analysis and measurement system is available that can survive unattended and in-situ.

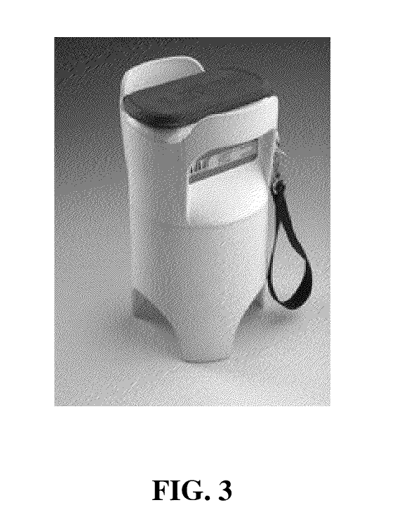

FIG. 3 is an illustration of an exemplary device including a sensor that is powered by a long-life power source and that can be immersed in a fluid, according to at least one embodiment. The sensor according to the present embodiment, because it is powered by a long-life power source, is equipped to collect environmental information of a fluid (e.g., liquid and/or gaseous environment) and relay information as to the conditions of a difficult to reach area. By obtaining power from the long-life power source illustrated in the example of FIG. 1, this exemplary sensor can remain active without external power being supplied thereto and can therefore obtain measurement information of environments which have heretofore proved difficult to monitor.

The remote long-life fluid measurement and analysis system of the present disclosure utilizes a long-life power source, such as the exemplary power sources described above, of a sufficient size and output power, to power the system for an extended period of time, such as 20-30 years, for example. Therefore, the exemplary fluid measurement and analysis system can provide a highly durable RF communication enabled device with commercially available sensors to collect and transmit desired information of the environment being monitored. For example, the remote long-life measurement and analysis system can be utilized in applications to measure flow, radioactivity, contaminant, hydrostatic pressure and other data, and be utilized for municipal flow, streams, and dam/utility applications.

According to an exemplary embodiment, the long-life fluid measurement and analysis system can include a sensor configured to be partially or wholly immersed in a fluid. The exemplary sensor can include a measurement device configured to measure environmental information of at least one of the fluid and an environment proximate to the fluid. The sensor can also include a transmitter configured to transmit the measured environmental information to a receiving device configured to receive the measured environmental information.

In this exemplary sensor, the processing unit 160 can be configured to convert the measured environmental information into a transmission signal, and control the transmitter 165, 180 to transmit the transmission signal wirelessly via a radio frequency at a predetermined period of time.

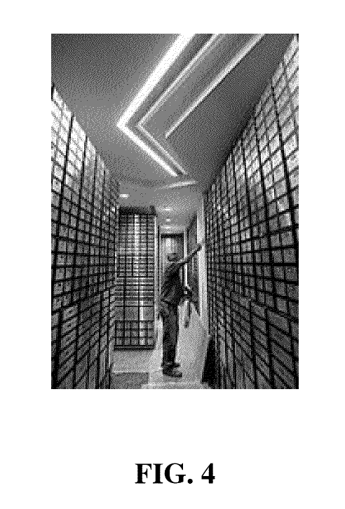

Another exemplary embodiment of the present disclosure provides a long-life off-grid enclosed space proximity change detector for detecting any change in a given space, such as in enclosed space, for example. FIG. 4 is an illustration of an exemplary environment in which a sensor powered by a long-life power source can be installed to detect changes in the environment, according to at least one embodiment. The exemplary long-life off-grid enclosed space proximity change detector detects changes in the layout of a predetermined area or enclosed space, as well as any general intrusion (allowed or otherwise) into the predetermined area or enclosed space. Examples of applications for the exemplary long-life off-grid enclosed space proximity change detector can include safe deposit boxes, secure storage spaces, or any area with controlled access. The exemplary long-life off-grid enclosed space proximity change detector enables a detection device, such as an ultrasonic emitter or an accelerometer, for example to “see” the layout of desired area, and can be configured to “wake up” and compare measured data from one time period against measured data of another time period.

The exemplary long-life off-grid enclosed space proximity change detector is capable of being queried remotely, such as by RF inquires, for example. The exemplary long-life off-grid enclosed space proximity change detector records and transmits any event that can be detected by a micro-accelerometer and/or changes to the space layout. Accordingly, an operator or technician can remotely query the proximity change detector. A positive response from the proximity change detector could, for example, detail any access to the predetermined area or enclosed space, as well as any changes to the layout of the predetermined area or enclosed space. The positive response can also identify a percentage change. Such access or change can then be matched to an official access list in which individuals and/or objects that are authorized to access and/or be located within the predetermined area or enclosed space. Any unauthorized access/change to the area or space layout can then be quickly monitored and determined, even if thousands of such spaces (e.g., safe deposit boxes) are within the query range of the data recorder.

The exemplary proximity change detector can be equipped with a sensor suite including one or more of an x, y, z accelerometer for detecting motion, an ultrasonic emitter/receiver which “sees” an object layout, and a camera for capturing image data. The proximity charge detector can be powered by any of the exemplary long-life power sources described above.

Accordingly, an exemplary embodiment of the present disclosure provides a sensor that can be configured to detect the introduction of an object within a predetermined area. Such a sensor can include a measurement device configured to measure environmental information of the predetermined area at a predetermined frequency and transmit the measured environmental information to the processing unit 160. The sensor can also include a memory unit (e.g., ROM 161, RAM 162, memory slot 190) that is configured to have recorded therein approved environmental data representing approved environmental information of the predetermined area. For example, the memory unit can have approved environmental information pre-recorded therein, or the memory unit can be updated with approved environmental information. The approved environmental information can, for example, denote environmental values that are expected to be sensed when an object does not intrude into the area to be monitored.

According to an exemplary embodiment, the exemplary object detection sensor can also include a transceiver (e.g., transmission unit 165, reception unit 166 and antenna 180) configured to transmit notification information representing a notification of the introduction of an object within the predetermined area, to a receiving device configured to receive the notification information. The processing unit 160 can be configured to compare the measured environmental information received from the measurement device with the approved environmental data recorded in the memory unit, to determine that an object has been introduced within the predetermined area upon determining that the measured environmental information differs from the approved environmental data. The processing unit 160 can then generate the notification information upon determining that an object has been introduced within the predetermined area, and control the transceiver (e.g., transmission unit 165, reception unit 166 and antenna 180) to transmit the notification information to the receiving device to indicate that an object has been introduced within the predetermined area.

According to an exemplary embodiment, the processing unit 160 can be configured to control the transceiver (e.g., transmission unit 165, reception unit 166 and antenna 180) to transmit the notification information wirelessly via a radio frequency at a predetermined period of time. In addition, the processing unit 160 can be configured to control the memory unit to record the notification therein. The transceiver can be configured to receive an operating instruction transmitted externally from the sensor, and transmit the received operating instruction to the processing unit 160 via the reception unit 166. The processing unit 160 can then be configured to, upon receiving the external operating instruction, cause the sensor to power on and initiate detection of an object within the predetermined area via the power control unit 164.

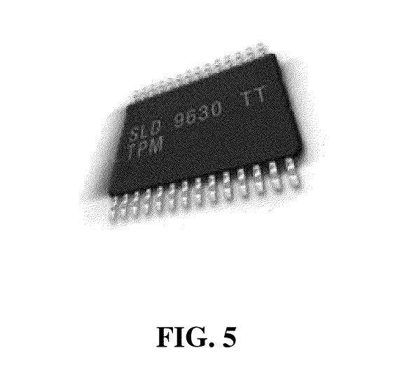

Another exemplary embodiment of the present disclosure provides a surface-mount encryption device with a volatile long-life (e.g., 20 years) key storage and volume intrusion response. FIG. 5 is an illustration of an exemplary surface mount encryption device powered by a long-life power source and mountable to a computer processing device, according to at least one embodiment.

Many current and future commercial, future and defense-oriented applications require a highly secure trusted platform module (TPM) for the security of data and communications. Conventional “secure” TPMs allow users to work with and store sensitive or confidential data by electronically protecting such data via encryption on the bit level. When an enabled computer is accessed by unauthorized personnel, data cannot be accessed. However, conventional TPM technology is commonly defeated using remedies that can be found on the Internet, for example.

In view of this phenomenon, the exemplary surface-mount encryption device provides a potted volume with a field-programmable gate array (FPGA) with a long-life (e.g., 20 years or longer) battery-powered backup. The 20 year or more battery can be any of the exemplary long-life power sources described above. A nickel isotope battery backup may be effective for as many as 50 years, for example. An intrusion sensor is fabricated integral to the device packaging. Intrusion leads to a loss in power, which leads to a dumping of the keys. Keys occupy a pseudo-random location in a memory space or array, making key-data extraction exceedingly difficult if not impossible. Potting material may contain additional components which render hardware-based data extraction or various kinds of imaging difficult or completely ineffective.

According to an exemplary embodiment, the surface mount encryption device being powered by any of the exemplary long-life power sources as described above, for example, can be mounted in a computer processing device. As used herein, a computer processing device is an electronic device configured to process data and read data from a computer-readable recording medium, including volatile and non-volatile memory. For example, a computer-processing device may be a personal computer (PC), including portable and desktop PCs, a gaming device, a control device configured to control the operation of another electronically operated device, a personal digital assistant (PDA), an enterprise digital assistant (EDA), a mobile telephone, a smart phone having voice and data communication capabilities, etc.

The surface mount encryption device can include a memory unit having recorded therein cryptographic keys (e.g., private key) for which at least one complementary cryptographic key (e.g., public key) is required to access encrypted data accessible in the computer processing device to which the surface mount encryption device is mounted. The exemplary surface mount encryption device can also include an intrusion detector (e.g., sensor) configured to detect an attempt to at least one of disable and modify the cryptographic keys recorded in the surface mount encryption device and/or the mounting of the surface mount encryption device in the computer processing device. The intrusion detector can notify the processing unit when detecting such an attempt.

The processing unit 160 can be configured to cause the memory unit to discard the cryptographic keys (e.g., dump the cryptographic keys), upon receiving notification of the attempt from the intrusion detector. For example, the processing unit 160 can be configured to erase the cryptographic keys recorded in the memory unit, upon receiving notification of the attempt from the intrusion detector. The processing unit can also be configured to control the memory unit to store data representing the detected attempt contemporaneously (i.e., at the same time) with detecting the attempt.

The above-described exemplary surface mount encryption device is configured to be powered by the long-life power source 120 comprised therein, independent of a power source of the computer processing unit to which the surface mount encryption device is mounted. Therefore, even if there is an attempt to alter power or an operation of the computer processing device, the security of the surface mount encryption device is ensured because its power source is independent from the computer processing device.

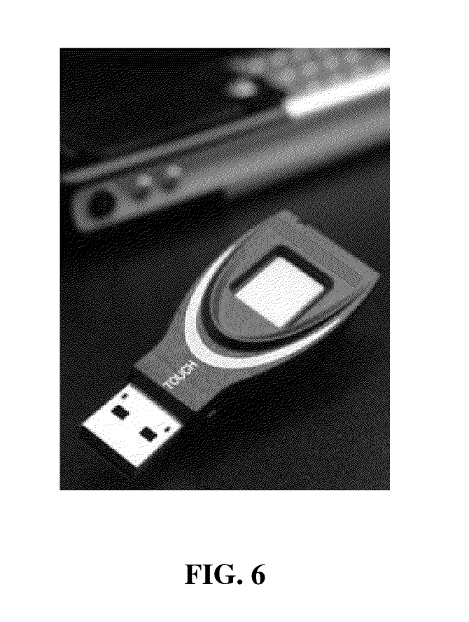

FIG. 6 is an illustration of an exemplary portable encryption device powered by a long-life power source and removably inserted into a communication port (e.g., USB drive) of a computer processing device, according to at least one embodiment. The present exemplary embodiment provides a portable encrypted data storage device with a voltage long-life (e.g., 20 years) key storage and intrusion response.

Conventional and future personal, commercial and defense-oriented applications require a highly secure means of transporting data from one computer to another. Conventional “secure” products such as USB biometric sticks allow users to work with and store sensitive or confidential data by protecting such data with encryption and requiring biometric inputs for unlocking. Unfortunately, these conventional products are easily defeated by using remedies that can be found on the Internet, for example.

The exemplary portable encrypted data storage device provides a potted volume with a flash-memory and a long-life (e.g., 20 years or longer) battery-power backup volatile-memory for key storage. The long-life battery may be tritium based, and may be any of the above-described exemplary long-life power sources. A nickel isotope battery backup may be effective for as many as 50 years, for example. An intrusion sensor is fabricated integral to the device packaging. Intrusion leads to a loss in power, which leads to a dumping of the keys. Keys occupy a pseudo-random location in a memory space or array, making key-data extraction exceedingly difficult if not impossible. Potting material may contain additional components which render hardware-based data extraction or various kinds of imaging difficult or completely ineffective.

Accordingly, the present disclosure provides a portable encryption device powered by a long-life power source and configured to be removably inserted into a communication port (e.g., USB drive) of a computer processing device. The exemplary portable encryption device can include a memory unit having recorded therein cryptographic keys (e.g., public key) for which at least one complementary cryptographic key (e.g., private key) is required to access encrypted data recorded in at least one of the memory unit and the computer processing device to which the portable encryption device is insertable thereinto. The exemplary portable encryption device can also include an intrusion detector (e.g., sensor) configured to detect an attempt to at least one of disable and modify the cryptographic keys recorded in the memory unit, and to notify the processing unit when detecting the attempt.

According to this exemplary embodiment, the processing unit 160 can be configured to cause the memory unit to discard the cryptographic keys (e.g., dump the keys), upon receiving notification of the attempt from the intrusion detector. For example, the processing unit 160 can be configured to erase the cryptographic keys recorded in the memory unit, upon receiving notification of the attempt from the intrusion detector. In addition, the processing unit can be configured to control the memory unit to store data representing the detected attempt contemporaneously (i.e., at the same time) with detecting the attempt.

The exemplary portable encryption device is powered by the long-life power source comprised in the portable encryption device, independent of a power source of the computer processing unit to which the portable encryption device is insertable thereinto. Therefore, even if there is an attempt to alter power or an operation of the computer processing device, the security of the portable encryption device is ensured because its power source is independent from the computer processing device.

The aforementioned exemplary applications described above are not limited to the exemplary betavoltaic power source, nuclear spin, remnant polarization, and radio-luminescent photovoltaic power sources described above. It is to be understood that any long-life power source, the meaning of which term having been defined herein, can be utilized to power any of the exemplary devices described above.

It will be appreciated by those skilled in the art that the present disclosure can be embodied in other specific forms without departing from the spirit or essential character thereof. The presently disclosed embodiments are considered in all respects to be illustrative and not restrictive.

What is claimed is:

1. A device comprising:
a long-life power source configured to supply operating power to the device for a duration of at least twenty years;
a package housing configured to secure the power source integral to the device;
a processing unit configured to control operative functions of the device; and
a power control unit configured to supply power to the processing unit based on the operating power supplied from the power source.

2. The device according to claim 1, wherein the device is a sensor configured to be embedded in a structural material, the sensor including:
a measurement device configured to measure environmental information of at least one of the structural material and an environment proximate to the structural material; and
a transmitter configured to transmit the measured environmental information to a receiving device configured to receive the measured environmental information.

3. The device according to claim 2, wherein the processing unit is configured to convert the measured environmental information into a transmission signal, and control the transmitter to transmit the transmission signal wirelessly via a radio frequency at a predetermined period of time.

4. The device according to claim 2, wherein the long-life power source comprises:
a p-n junction; and
a beta emitter in contact with the p-n junction for energizing the power source, wherein:
the package housing surrounds the p-n junction and beta emitter, and
the beta emitter is tritium either in a polymerized state or bound to a metal foil in a tritide state.

5. The device according to claim 2, wherein the long-life power source is configured to generate electrical power from one of a nuclear-spin effect and a remnant polarization effect.

6. The device according to claim 1, wherein the device is a sensor configured to be partially or wholly immersed in a fluid, the sensor including:
a measurement device configured to measure environmental information of at least one of the fluid and an environment proximate to the fluid; and
a transmitter configured to transmit the measured environmental information to a receiving device configured to receive the measured environmental information.

7. The device according to claim 6, wherein the processing unit is configured to convert the measured environmental information into a transmission signal, and control the transmitter to transmit the transmission signal wirelessly via a radio frequency at a predetermined period of time.

8. The device according to claim 6, wherein the long-life power source comprises:
a p-n junction; and
a beta emitter in contact with the p-n junction for energizing the power source, wherein:
the package housing surrounds the p-n junction and beta emitter, and
the beta emitter is tritium either in a polymerized state or bound to a metal foil in a tritide state.

9. The device according to claim 6, wherein the long-life power source is configured to generate electrical power from one of a nuclear-spin effect and a remnant polarization effect.

10. The device according to claim 1, wherein the device is a sensor configured to detect the introduction of an object within a predetermined area, the sensor including:
a measurement device configured to measure environmental information of the predetermined area at a predetermined frequency and transmit the measured environmental information to the processing unit;
a memory unit configured to have recorded therein approved environmental data representing approved environmental information of the predetermined area; and
a transceiver configured to transmit notification information representing a notification of the introduction of an object within the predetermined area, to a receiving device configured to receive the notification information,
wherein the processing unit is configured to compare the measured environmental information received from the measurement device with the approved environmental data recorded in the memory unit, to determine that an object has been introduced within the predetermined area upon determining that the measured environmental information differs from the approved environmental data, to generate the notification information upon determining that an object has been introduced within the predetermined area, and to control the transceiver to transmit the notification information to the receiving device to indicate that an object has been introduced within the predetermined area.

11. The device according to claim 10, wherein the processing unit is configured to control the transceiver to transmit the notification information wirelessly via a radio frequency at a predetermined period of time.

12. The device according to claim 10, wherein the processing unit is configured to control the memory unit to record the notification therein.

13. The device according to claim 10, wherein the transceiver is configured to receive an operating instruction transmitted externally from the sensor, and transmit the received operating instruction to the processing unit,
wherein the processing unit is configured to, upon receiving the operating instruction, cause the sensor to power on and initiate detection of an object within the predetermined area.

14. The device according to claim 10, wherein the long-life power source comprises:
a p-n junction; and
a beta emitter in contact with the p-n junction for energizing the power source, wherein:
the package housing surrounds the p-n junction and beta emitter, and
the beta emitter is tritium either in a polymerized state or bound to a metal foil in a tritide state.

15. The device according to claim 10, wherein the long-life power source is configured to generate electrical power from one of a nuclear-spin effect and a remnant polarization effect.

16. The device according to claim 1, wherein the device is a surface mount encryption device configured to be mounted in a computer processing device, the surface mount encryption device including:
a memory unit having recorded therein cryptographic keys for which at least one complementary cryptographic key is required to access encrypted data accessible in the computer processing device to which the surface mount encryption device is mounted; and
an intrusion detector configured to detect an attempt to at least one of disable and modify the cryptographic keys recorded in the surface mount encryption device and/or the mounting of the surface mount encryption device in the computer processing device, and to notify the processing unit when detecting the attempt, wherein:
the processing unit is configured to cause the memory unit to discard the cryptographic keys, upon receiving notification of the attempt from the intrusion detector.

17. The device according to claim 16, wherein the processing unit is configured to erase the cryptographic keys recorded in the memory unit, upon receiving notification of the attempt from the intrusion detector.

18. The device according to claim 16, wherein the surface mount encryption device is configured to be powered by the long-life power source comprised in the surface mount encryption device, independent of a power source of the computer processing unit to which the surface mount encryption device is mounted.

19. The device according to claim 16, wherein the processing unit is configured to control the memory unit to store data representing the detected attempt contemporaneously with detecting the attempt.

20. The device according to claim 16, wherein the long-life power source comprises:
a p-n junction; and
a beta emitter in contact with the p-n junction for energizing the power source, wherein:
the package housing surrounds the p-n junction and beta emitter, and
the beta emitter is tritium either in a polymerized state or bound to a metal foil in a tritide state.

21. The device according to claim 16, wherein the long-life power source is configured to generate electrical power from one of a nuclear-spin effect and a remnant polarization effect.

22. The device according to claim 1, wherein the device is a portable encryption device configured to be removably inserted into a communication port of a computer processing device, the portable encryption device comprising:
a memory unit having recorded therein cryptographic keys for which at least one complementary cryptographic key is required to access encrypted data recorded in at least one of the memory unit and the computer processing device to which the portable encryption device is insertable thereinto; and
an intrusion detector configured to detect an attempt to at least one of disable and modify the cryptographic keys recorded in the memory unit, and to notify the processing unit when detecting the attempt, wherein:
the processing unit is configured to cause the memory unit to discard the cryptographic keys, upon receiving notification of the attempt from the intrusion detector.

23. The device according to claim 22, wherein the processing unit is configured to erase the cryptographic keys recorded in the memory unit, upon receiving notification of the attempt from the intrusion detector.

24. The device according to claim 22, wherein the portable encryption device is configured to be powered by the long-life power source comprised in the portable encryption device, independent of a power source of the computer processing unit to which the portable encryption device is insertable thereinto.

25. The device according to claim 22, wherein the processing unit is configured to control the memory unit to store data representing the detected attempt contemporaneously with detecting the attempt.

26. The device according to claim 22, wherein the long-life power source comprises:
a p-n junction; and
a beta emitter in contact with the p-n junction for energizing the power source, wherein:
the package housing surrounds the p-n junction and beta emitter, and
the beta emitter is tritium either in a polymerized state or bound to a metal foil in a tritide state.

27. The device according to claim 22, wherein the long-life power source is configured to generate electrical power from one of a nuclear-spin effect and a remnant polarization effect.
